(19) United States
(12) Patent Application Publication
(10) Pub. No.: US 2012/0279353 A1
(43) Pub. Date: Nov. 8, 2012

(54) SYSTEM AND METHOD FOR PRODUCING METALLIC IRON

(75) Inventors: David J. Englund, Bovey, MN (US); Mark Schlichting, Crawfordsville, IN (US); John Meehan, Conway, AR (US); Jeremiah Crouch, Conway, AR (US); Logan Wilson, Hot Springs, AR (US)

(73) Assignee: NU-IRON TECHNOLOGY, LLC, Charlotte, NC (US)

(21) Appl. No.: 13/498,806

(22) PCT Filed: Sep. 29, 2010
(86) PCT No.: PCT/US10/50730

§ 371 Date: May 18, 2012

Related U.S. Application Data
(60) Provisional application No. 61/246,787, filed on Sep. 29, 2009.

(51) Int. Cl. C21B 11/08; F27B 3/28; F27B 3/22; F27B 3/00; F27B 3/26

(52) U.S. Cl. 75/380; 75/484; 75/384; 266/200; 266/99

(57) ABSTRACT

A method for producing metallic iron including providing a hearth furnace having an entry end and a discharge end, a moveable hearth, and an exhaust stack positioned toward the entry end of the furnace, providing a carbonaceous hearth layer above the hearth, providing a layer of reducible material comprising reducing material and iron bearing material, delivering a flow of gases into the hearth furnace through burners, gas injection ports, or a combination thereof directing a flow of gases toward the entry end selected from combustible fuel, oxygen and carbon dioxide, oxygen and flue gas, oxygen and air, or a combination thereof to heat the furnace to a temperature sufficient to at least partially reduce the reducible material, increasing the velocity of the flow of gas to greater than 4 feet per second along the furnace, and heating the layer of reducible material to at least partially reduce the reducible material.

This international patent application claims priority to and the benefit of U.S. patent application 61/246,787, filed Sep. 29, 2009.

### GOVERNMENT INTERESTS

The present invention was made with support by the Department of Energy, Sponsor Award DE-FG36-05GO15185. The United States government may have certain rights in the invention.

### BACKGROUND AND SUMMARY

This invention relates generally to a system and method for producing metallic iron nodules (NRI) by thermally reducing iron oxide in a moving hearth furnace. Metallic iron nodules have been produced by reducing iron oxide such as iron ores, iron pellets and other iron sources. Various such methods have been proposed so far for directly producing metallic iron nodules from iron ores or iron oxide pellets by using reducing agents such as coal or other carbonaceous material.

Various types of hearth furnaces have been described and used for direct reduction of metallic iron nodules (NRI). One type of hearth furnace used to make NRI is a rotary hearth furnace (RHF). The rotary hearth furnace is partitioned annularly into a drying/preheating zone, a reduction zone, a fusion zone, and a cooling zone, between the supply location and the discharge location of the furnace. An annular hearth is supported rotationally in the furnace to move from zone to zone carrying reducible material the successive zones. In operation, the reducible material comprises a mixture of iron ore or other iron oxide source and reducing material such as carbonaceous material, which is charged onto the annular hearth and initially subject to the drying/preheat zone. After drying and preheating, the reducible material is moved by the rotating annular hearth to the reduction zone where the iron ore is reduced in the presence of the reducing material, and then to the fusion zone where the reduced reducible material is fused into metallic iron nodules, using one or more heating sources (e.g., natural gas burners). The reduced and fused NRI product, after completion of the reduction process, is cooled on the moving annular hearth in the cooling zone to prevent reoxidation and facilitate discharge from the furnace. Another type of furnace used for making NRI is the linear hearth furnace such as described in U.S. Pat. No. 7,413,592, where similarly prepared mixtures of reducible material are moved on moving hearth sections or cars through a drying/preheating zone, a reduction zone, a fusion zone, and a cooling zone, between the charging end and discharging end of a linear furnace while being heated above the melting point of iron.

A limitation of these methods and systems of making metallic iron nodules has been their energy efficiency. The iron oxide bearing material and associated carbonaceous material generally had to be heated in a reduction furnace to about 2500° F. (about 1370° C.), or higher, to reduce the iron oxide and produce metallic iron nodules. The reduction process has generally required natural gas methane or propane to be burned to produce the heat necessary to heat the iron oxide bearing material and associated carbonaceous material to the high temperatures to reduce the iron oxide and produce a metallic iron material. Furthermore, the reduction process involved production of volatiles in the furnace that had to be removed from the furnace and secondarily combusted to avoid an environmental hazard, which added to the energy needs to perform the iron reduction. See, e.g., U.S. Pat. No. 6,390,810.

In the past, furnace systems for production of iron nodules heated by oxy-fuel burners had reduced efficiency due to loss of heat through the exhaust stack. Recovery of heat through preheating of oxygen and fuel entering the oxy-fuel burners has not been possible as oxygen gas and fuel sources contain too little mass to efficiently transfer heat from one location in the furnace to another, and tend to be more volatile when heated. Additionally, the oxy-fuel burners have produced flame temperatures resulting in internal burner temperatures causing damage to the burner and the furnace refractory. We have found a method and reduction furnace system for making metallic iron nodules that reduces the energy consumption needed to reduce the iron oxide bearing material to produce metallic iron nodules more efficiently.

A method of production of metallic iron is disclosed comprising the steps of
assembling a hearth furnace comprising an entry end and a discharge end, and a moveable hearth comprising refractory material adapted to move reducible material through the furnace from the entry end to the discharge end, and an exhaust stack positioned toward the entry end of the furnace,
providing a hearth material layer comprising at least carbonaceous material above the refractory material,
providing a layer of reducible material comprising a mixture of at least reducing material and reducible iron bearing material arranged in a plurality of discrete portions above at least a portion of the hearth material layer,
delivering a flow of gases into the hearth furnace through burners, gas injection ports, or a combination thereof directing a flow of gases toward the entry end selected from a group consisting of combustible fuel, oxygen and carbon dioxide, oxygen and flue gas, oxygen and air, or a combination thereof to heat the furnace to a temperature sufficient to at least partially reduce the reducible material,
increasing the velocity of the flow of gas to greater than 4 feet per second along the furnace,
and heating the layer of reducible material to at least partially reduce the reducible material to form metallic iron nodules.

The roof of the furnace may be higher at the entry end than the discharge end of the furnace. The roof of the furnace may be sloped, stepwise or seesaw to provide the desired flow of gases through the furnace.

In one alternative, at least one burner may be provided adjacent the discharge end directing a flow of gases toward the entry end. Combustible fuel delivered to the burners may be natural gas, methane, propane, syn-gas, coal or other combustible fuel. Alternatively or in addition, a stream of diluted oxygen gas may be provided to control flame temperature and flame stability and inhibit damage to the refractories in the furnace. The stream of diluted oxygen gas may be oxygen diluted with carbon dioxide, air or nitrogen, and/or process flue gas from the exhaust stack or some other source. The stream of diluted oxygen gas is such as to provide the desired flame temperature and flame stability and heat to the furnace, and to provide a gas flow of appropriate mass to conduct heat in and through the furnace. However, if a sequestration of carbon dioxide is desired from the exhaust stack gases or a portion thereof the dilution of the oxygen should be with carbon dioxide or flue gas relatively high in carbon dioxide. The combustible fuel may also be preheated where desired to deliver more heat to the furnace through the flow of gases into the furnace.

The method may further include delivering from the roof or side walls of the furnace diluted oxygen gas along the furnace from the exit end to the entry end. The oxygen gas may be diluted with carbon dioxide, air or nitrogen, process flue gas from the exhaust stack or some other source the same as the combustible fuel delivered to the burner, but optionally with a different percentage of dilution along the furnace to tailor temperature control in the furnace as needed in the different stages of the conversion and fusion process in reducing the reducible material to form metallic iron nodules. However, again, if a sequestration of carbon dioxide is desired from the exhaust stack gas or a portion thereof, the dilution of the oxygen should be with carbon dioxide or flue gas relatively high in carbon dioxide. Like the flow of gas delivered to at least the burner at the discharge end of the furnace, the diluted oxygen gas may also be preheated for delivery along the furnace where desired to deliver more heat to the furnace through the roof or side walls of the furnace.

The flow of diluted oxygen gas may include delivering oxygen gas and at least one of carbon dioxide, flue gas, air, and nitrogen at a plurality of locations along the furnace. The flow of diluted oxygen gas may include between about 10% and 40% oxygen gas by volume, and may be between about 15% and 35% oxygen gas by volume. Alternatively, the flow of oxygen gas and may be between 25% and 40% oxygen gas by volume.

The method may include the step of delivering a flow of fuel into the furnace above the reducible material. Delivering a flow of fuel may include delivering fuel above the reducible material at a plurality of locations along the furnace. The fuel may be one selected from the group consisting of syn-gas, methane, propane, natural gas, coal and a combination of two or more thereof.

Additionally, the method may include sensing the temperature of the furnace at a desired location, and delivering the flow of fuel above the reducible material responsive to the sensed temperature.

The method may include processing at least a portion of the flue gas in a gasifier to produce syn-gas, and delivering a flow of the syn-gas into the furnace above the reducible material. The syn-gas may be preheated by directing flue gas through a heat exchanger and preheating the syn-gas in the heat exchanger.

The flue gas may be processed to produce a gas stream having a composition of at least 90% carbon dioxide, and may be at least 95% carbon dioxide, by oxidizing carbon monoxide and hydrogen, treating the gas stream to remove at least one of sulfur-containing and halogen-containing compounds, and condensing water vapor from the gas stream. The flow of diluted oxygen gas delivered to the furnace may include carbon dioxide from the gas stream processed from the flue gas. The gas stream of carbon dioxide may be preheated by directing flue gas through a heat exchanger and preheating the carbon dioxide in the heat exchanger.

The method may include sensing the temperature of the furnace at a desired location, and delivering the flow of diluted oxygen gas responsive to the sensed temperature. Alternatively or in addition, the method may include sensing the oxygen concentration in the flue gas, and delivering the flow of diluted oxygen gas responsive to the sensed oxygen concentration. The flow of diluted oxygen gas may be delivered to the furnace through a plurality of gas injection lances and/or gas injection ports.

The step of providing a layer of reducible material may include discrete portions being pre-formed briquettes or balls, or compacts made in situ.

The present method permits metallic iron to be produced while recovering waste heat from the exhaust stack. In the method, the reducible material in the conversion zone may be heated to the temperature between about 1800 and 2350° F. (about 980 and about 1290° C.). Further, reducible material in the fusion zone may be heated to the temperature between about 2400 and 2550° F. (about 1310 and about 1400° C.). Additionally, the hearth furnace may have a drying zone and the drying zone may be heated to a temperature between about 300-600° F. (150-315° C.). The hearth furnace may also include a cooling zone and/or a cooling zone outside the furnace downstream of the hearth furnace.

The present method of making metallic iron nodules may include the additional step of providing an overlayer of coarse carbonaceous material over at least a portion of the layer of reducible material either before introduction into the furnace as described in PCT/US2007/074471, filed Jul. 26, 2007, or adjacent introduction of the heated reducible material to the fusion zone as described in Ser. No. 12/569,176, filed on Sep. 29, 2009, with this application. The coarse carbonaceous material is greater than 6 mesh in size and may have an average particle size greater than an average particle size of the hearth material layer carbonaceous material. The coarse carbonaceous material may be between 6 mesh and ½ inch in size.

If desired, the oxygen gas may be delivered to the conversion zone and the fusion zone through a plurality of gas injection lances and/or gas injection ports.

A stoichiometric amount of reducing material is the amount necessary for complete metallization and formation of metallic iron nodules from a predetermined quantity of reducible iron bearing material. At least a portion of the reducible material has a predetermined quantity of reducible iron bearing material and between about 80 percent and about 110 percent of the stoichiometric amount of reducing material necessary for complete iron reduction of the reducible iron bearing material, or metallization, where the iron bearing material includes waste material such as mill scale as described in International Patent Application PCT/US2010/021790, filed Jan. 22, 2010. Alternatively, at least a portion of the reducible material has a predetermined quantity of reducible iron bearing material and between about 70 percent and about 90 percent of the stoichiometric amount of reducing material necessary for complete iron reduction of the reducible iron bearing material where the iron bearing material is magnetite and/or hematite.

The reducible iron bearing material may contain at least a material selected from the group consisting of mill scale, magnetite, hematite, and combinations thereof in the proportions as described above. The reducing material may contain at least a material or mixture of materials selected from the group consisting of, anthracite coal, coke, char, sub-bituminous coal, and bituminous coal.

Also disclosed is a hearth furnace for producing metallic iron comprising
an entry end and a discharge end, and a moveable hearth therebetween comprising refractory material adapted to move reducible material through the furnace from the entry end to the discharge end,
an exhaust stack positioned toward the entry end of the furnace,
at least one burner adjacent the discharge end positioned to direct a flow of gases toward the entry end, and
at least one gas injection port adapted to deliver a flow of gases selected from a group consisting of combustible fuel, oxygen and carbon dioxide, oxygen and flue gas, oxygen and air, or a combination thereof, into the hearth furnace to heat the furnace to a temperature sufficient to at least partially reduce the reducible material.

An alternative hearth furnace is disclosed for producing metallic iron comprising
an entry end and a discharge end, and a moveable hearth therebetween comprising refractory material adapted to move reducible material through the furnace from the entry end to the discharge end,
an exhaust stack positioned toward the entry end of the furnace,
at least one gas injection port adapted to deliver a flow of gases selected from a group consisting of combustible fuel, oxygen and carbon dioxide, oxygen and flue gas, oxygen and air, or a combination thereof, into the hearth furnace to heat the furnace to a temperature sufficient to at least partially reduce the reducible material, and
a plurality of flow restrictions along the furnace adapted to increase the velocity of the flow of gas to greater than 4 feet per second along the furnace.

In either furnace, a plurality of gas injection lances may be positioned along the furnace adapted to deliver the flow of diluted oxygen gas. The hearth furnace may further comprise a plurality of gas injection ports positioned along the furnace adapted to deliver a flow of fuel into the furnace above the reducible material.

The hearth furnace may have a sloped roof higher at the entry end and lower at the discharge end. Alternatively or in addition, the roof of the furnace may be sloped, stepwise or seesaw to provide the desired counter-flow of gases through the furnace.

A temperature sensor may be provided adapted to sensing the temperature of the furnace at a desired location. The hearth furnace may include a fuel metering valve adapted to delivering the flow of fuel above the reducible material responsive to the sensed temperature. Alternatively or in addition, a metering device may be provided adapted to delivering the flow of diluted oxygen gas to the furnace responsive to the sensed temperature.

Alternatively or in addition, the hearth furnace may include a gas analyzing sensor adapted to sensing the oxygen concentration in flue gas exhausted from the exhaust stack. The fuel metering valve may be adapted to delivering the flow of fuel above the reducible material responsive to the sensed oxygen concentration. Also, the metering device may be adapted to delivering the flow of diluted oxygen gas to the furnace responsive to the sensed oxygen concentration.

A gasifier may be provided adapted to processing at least a portion of flue gas from the exhaust stack to produce syn-gas. The hearth furnace may include a scrubber adapted to processing at least a portion of flue gas from the exhaust stack to produce a gas stream comprising at least 90% carbon dioxide. Alternatively, the gas stream may comprise at least 95% carbon dioxide.

The hearth furnace may include a heat exchanger connected to at least a portion of the flue gas adapted to preheat the carbon dioxide or other gas for diluting oxygen in the heat exchanger. Alternatively or in addition, a heat exchanger may be connected to at least a portion of the flue gas adapted to preheat the flow of fuel in the heat exchanger.

The above summary of the present invention is not intended to describe each embodiment or every implementation of the present invention. A more complete understanding of the invention and its advantages will become apparent by referring to the following detailed description and claims in conjunction with the accompanying drawings.

### BRIEF DESCRIPTION OF THE DRAWINGS

FIG. 1 is a block diagram of one or more general embodiments of a metallic iron nodule process;

FIG. 2 is an elevational cross sectional view illustrating a hearth furnace for producing metallic iron material and a method for producing same;

FIG. 3 is an elevational cross sectional view illustrating an alternative hearth furnace for producing metallic iron material and a method for producing same;

FIG. 4 is an elevational cross sectional view illustrating yet another alternative embodiment of a hearth furnace for producing metallic iron material including a horizontal baffle;

FIG. 5 is an elevational cross sectional view illustrating an alternative hearth furnace for producing metallic iron material and a method for producing same;

FIG. 6 is an elevational cross sectional view illustrating an alternative hearth furnace for producing metallic iron material and a method for producing same;

FIG. 7 is an elevational cross sectional view illustrating an alternative hearth furnace for producing metallic iron material and a method for producing same;

FIG. 8 is a cross sectional perspective view through a gas delivery channel of the present invention;

FIG. 9 is a perspective view through an alternative gas delivery channel of the present invention;

FIG. 10A is a front elevational view of an oxy-fuel burner;

FIG. 10B is a cross sectional view of the oxy-fuel burner of FIG. 10A;

FIG. 11A is a front elevational view of an alternate oxy-fuel burner;

FIG. 11B is a cross sectional view of the oxy-fuel burner of FIG. 11A;

FIG. 12 is a block diagram of another general embodiment of a metallic iron nodule process;

FIG. 13 is a schematic flow diagram of a CO₂ and heat recovery system for use with the present hearth furnace system; and

FIG. 14 is a schematic flow diagram of oxygen and CO₂ delivery for use with the present hearth furnace system.

### DETAILED DESCRIPTION OF THE DRAWINGS

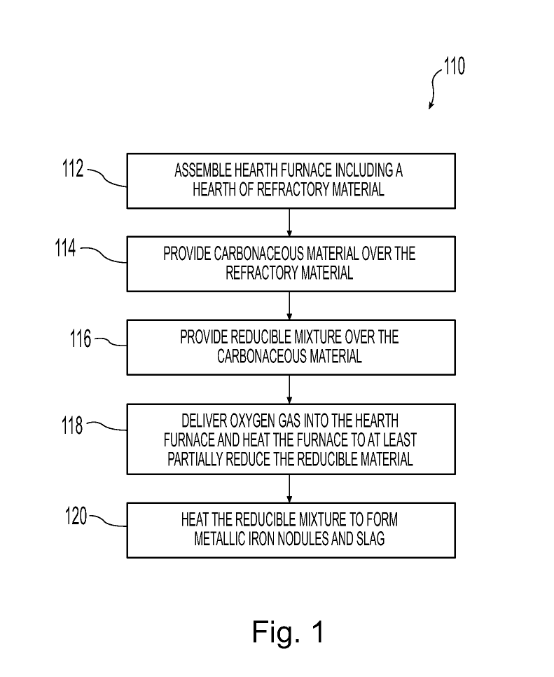

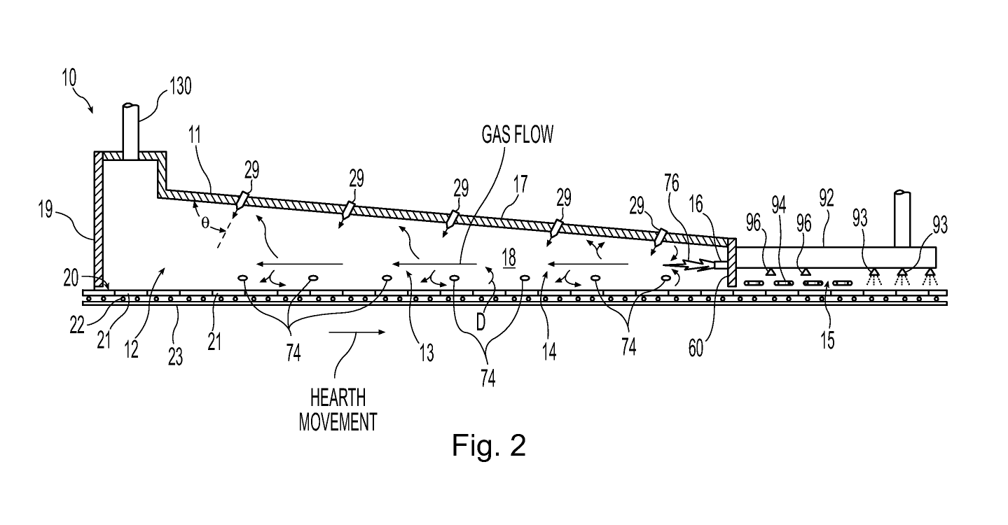

FIG. 1 shows a block diagram of illustrative embodiments of a method 110 for making metallic iron nodules. The method 110 for making metallic iron nodules may be performed in the hearth furnace described with further reference to FIG. 2.

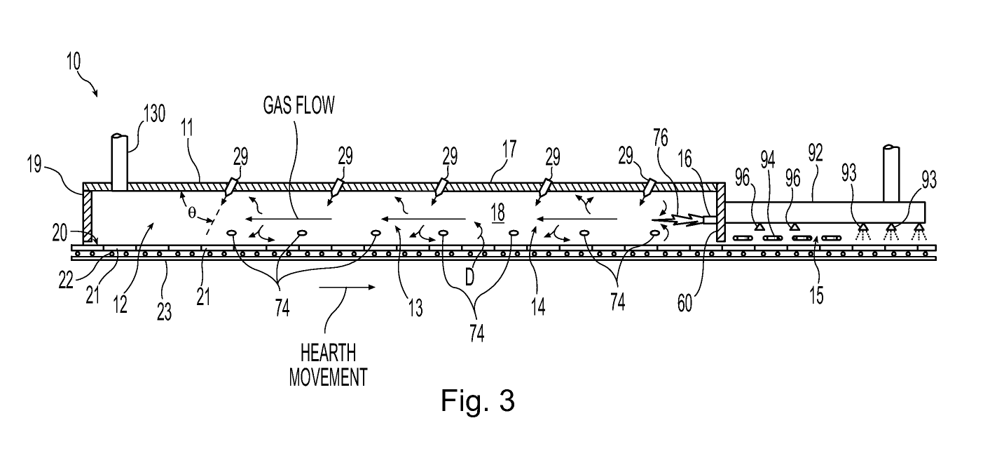

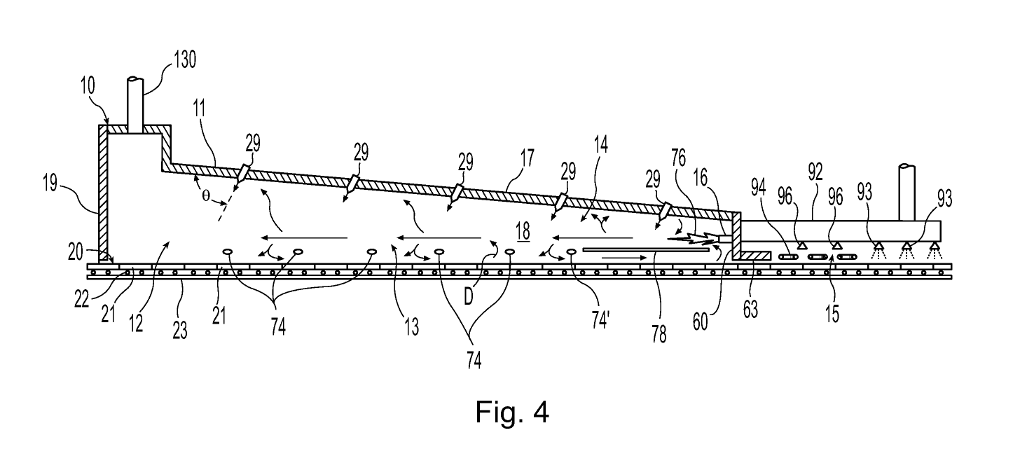

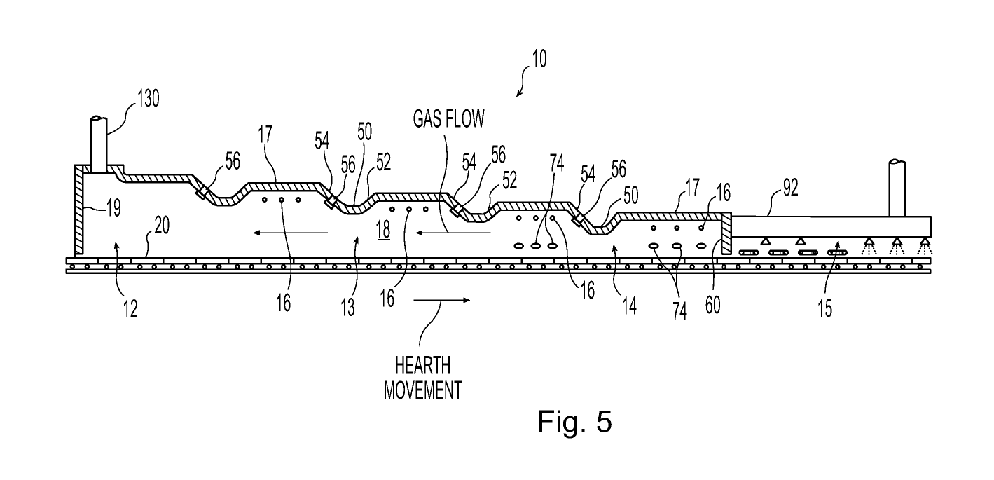

As shown in block 112 of FIG. 1 and FIG. 2, a hearth furnace 10 may be provided for producing metallic iron from iron ore and other iron oxide sources. The furnace 10 has a furnace housing 11 and a movable hearth 20 internally lined with a refractory material suitable to withstand the temperatures involved in the metallic reduction carried out in the furnace. The furnace housing 11 includes a furnace roof and sidewalls 18. The furnace housing 11 may include a flat roof 17, as shown in FIG. 3. The furnace housing 11 may include a sloped roof 17 higher at the entry end and lower at the discharge end as shown in FIGS. 2 and 4. Alternatively, the roof of the furnace may have a stepped roof higher at the entry end and lower at the discharge end such as shown in FIGS. 5 through 7. In other embodiments not shown, the roof of the furnace may be otherwise sloped, stepwise or seesaw to provide the desired counter-flow of gases through the furnace. The roof 17 may be sloped such that the roof 17 is positioned higher at the drying/preheating zone 12 adjacent the entry end of the furnace and lower in the fusion zone 14 adjacent the discharge end of the furnace. The roof height may be about four feet or less above the hearth 20 at the end of the fusion zone 14 of the furnace. In the furnace of FIG. 2, the length of the furnace may be about 25 times the width. Alternatively, the length of the furnace may be between about 12 and 30 times the width.

The refractory material lining the interior of the furnace may be, for example, refractory board, refractory brick, ceramic brick, or a castable refractory material. More than one refractory material may be used in different locations as desired. For example, a combination of refractory board and refractory brick may be selected to provide additional thermal protection for any underlying substructure. The hearth 20 may include a supporting substructure that moves the refractory material (e.g., a refractory lined hearth) forming hearth 20 through the furnace. The supporting substructure may be formed from one or more different materials, such as, for example, stainless steel, carbon steel, or other metals, alloys, or combinations thereof that have suitable high temperature characteristics for furnace operation.

The hearth furnace 10 is divided into at least a conversion zone 13 capable of providing a reducing atmosphere for reducible material, and a fusion zone 14 capable of providing an atmosphere to at least partially form metallic iron material. A drying/preheating zone 12 may be provided in or adjacent the furnace housing capable of providing a drying/preheating atmosphere for the reducible material. Additionally, a cooling zone 15 capable of providing a cooling atmosphere for reduced material containing metallic iron material may be provided in or adjacent the furnace housing immediately following the fusion zone 14. As noted, the cooling zone may be in the furnace housing 11, but as shown in FIGS. 2 thorough 4, the cooling zone may be provided outside the furnace housing. Also as noted, the drying/preheating zone maybe provided inside or outside the furnace housing in desired embodiments.

In any case, the conversion zone 13 is positioned between the drying/preheating zone 12 and the fusion zone 14 and is the zone in which volatiles from the reducible material, including carbonaceous material, is fluidized, as well as the zone in which at least the initial reduction of metallic iron material occurs. The entry end of the hearth furnace 10, at the drying/preheating zone 12, may be at least partially closed by a restricting baffle 19 that may inhibit fluid flow between the outside ambient atmosphere and the atmosphere of the drying/preheating zone 12, yet provides clearance so as not to inhibit the movement of reducible material into the furnace housing 11. Additionally, a baffle 60 may be positioned between the fusion zone 14 and the cooling zone 15. The discharge baffle 60 may extend to within a few inches of the reducible material positioned on the hearth 20 as reducible material moves through the furnace housing 11 to inhibit direct fluid communication between the atmosphere of the fusion zone 14 and the atmosphere of the cooling zone 15, yet provide clearance so as not to inhibit the movement of reducible material out of the furnace housing 11. The baffles 19, 60 may be made of suitable refractory material such as silicon carbide or a metal material if the temperatures are sufficiently low. The pressure of the atmosphere in the hearth furnace 10 is typically maintained at a positive pressure compared to the ambient atmosphere to further inhibit fluid flow from the ambient atmosphere to the hearth furnace. The method of producing metallic iron nodules may therefore include reducing the reducible material in the hearth furnace 10 to metallic iron nodules substantially free of air ingress from the surrounding environment.

The hearth 20 provided within the furnace housing 11 may comprise a series of movable hearth cars 21, which are positioned contiguously end to end as they move through the furnace housing 11. Hearth cars 21 may move on wheels 22 that typically engage rails 23. The upper portion of the hearth cars 21 are lined with a refractory material suitable to withstand the temperatures for reduction of the iron oxide bearing material into metallic iron nodules as explained herein. The hearth cars are positioned contiguously end to end to form hearth 20 and move through the furnace housing 11, so that the lower portions of the hearth cars are not damaged by the heat generated in the furnace as reduction of the iron oxide-bearing material into metallic iron nodules proceeds. Alternatively, the hearth 20 may be a moving belt or other suitable conveyance medium provided with refractory material for the temperatures of the furnace atmospheres.

The zones of the furnace 10 are generally characterized by the temperature reached in each zone and the processing of reducible material in each zone. In the drying/preheating zone, moisture is driven off from the reducible material and the reducible material is heated to a temperature short of substantial fluidization of volatiles in and associated with the reducible material positioned on the hearth cars 21. The design is to reach in the drying/preheating atmosphere a cut-off temperature in the reducible material just short of substantial volatilization of carbonaceous material in and associated with the reducible material. This temperature is generally in the range of about 200-400° F. (90-200° C.), and is selected usually depending in part on the particular composition of the reducible material and the particular composition of carbonaceous material. One or more preheating burners 26 may be provided in the drying/preheating zone, for example, in the side walls of the furnace housing 11. The preheating burners 26 may be oxy-fuel burners or air/natural gas fired burners as desired, depending on the desired disposition of the stack gas from the drying/preheating zone and further processing of that stack gas.

The conversion zone 13 is characterized by heating the reducible material to drive off remaining moisture and most of the remaining volatiles in the reducible material, and heating the reducible material to at least partially reduce the reducible material. The heating in the conversion zone 13 may initiate the reduction reaction in forming the reducible material into metallic iron nodules and slag. The conversion zone 13 is generally characterized by heating the reducible material to about 1800 to 2350° F. (about 980° C. to about 1290° C.), or higher, depending on the particular composition and form of reducible material of the particular embodiment.

Referring to block 120 of FIG. 1, the fusion zone 14 involves further heating the reducible material, now absent most volatile materials, to at least partially reduce the iron bearing material. The heating in the fusion zone 14 may be sufficient to reduce and melt the iron bearing material to form metallic iron nodules (NRI) and slag. In the production of metallic iron nodules, the fusion zone generally involves heating the reducible material to about 2400 to 2550° F. (about 1310-1400° C.), or higher, so that metallic iron nodules are formed with a low percentage of iron oxide in the metallic iron. If the method is carried out efficiently, there will also be a low percentage of iron oxide in the slag, since the method is designed to reduce very high percentage of the iron oxide in the reducible material to metallic iron. In one alternative, the temperature in the fusion zone is selected to produce direct reduced iron.

Combustion gases and other furnace gases may be delivered as a flow of flue gas from the furnace through an exhaust stack 130. FIG. 2 shows an exemplary placement of exhaust stack 130 adjacent the drying/preheating zone. Alternatively, the exhaust stack 130 may be positioned adjacent the conversion zone 13 to enable combustion of volatile matter fluidized in the drying/preheating zone prior to exiting the furnace. In any event, the exhaust stack 130 is positioned near the entry end of the furnace 10 so that the furnace roof is generally rising in the direction of primary gas flow.

In the configuration shown in FIGS. 2 through 4, at least one burner is provided adjacent the discharge end of the furnace directing a flow of gases toward the entry end. As shown in FIGS. 2 through 4, one or more burners 16 are positioned adjacent the fusion zone 14 positioned so that the burners 16 are directed substantially horizontally toward the entry end of the furnace 10. The position of the burners 16 provides radiant heat from the burner flame to form metallic iron nodules in the fusion zone. In this region temperatures may exceed 2600° F. (about 1430° C.).

The burners 16 are directed counter-current to the direction of travel of the hearth. The burners 16 may produce a nozzle velocity between about 300 and 500 feet per second. The gases from the burner and the combustion gases therefrom form a primary flow of gases from the burners 16 toward the entry end of the furnace toward the exhaust stack 130. Additionally, the burners 16 provides an induced draft of gases near the reducible material drawing the gases into the flame to be burned, shown as D in FIGS. 2 through 4. While the burners 16 form a flow of gases toward the entry end of the furnace counter to the movement of the hearth, the flow of gases adjacent the hearth may be in the direction of movement of the hearth because of the draft of the burner.

The primary flow of gases may be supplemented with oxygen and/or fuel for combustion. At least one gas injection port may be provided adjacent the discharge end of the furnace adapted to deliver a flow of gases selected from a group consisting of combustible fuel, oxygen and carbon dioxide, oxygen and flue gas, oxygen and air, or a combination thereof, into the hearth furnace to heat the furnace to a temperature sufficient to at least partially reduce the reducible material.

As shown in FIGS. 2 through 4, gas injection ports 29 may be positioned in the roof 17 of the furnace housing 11 of the conversion zone 13 and the fusion zone 14 to provide additional energy for generation of heat and reduction into metallic iron in the furnace. The gas injection ports 29 may be slots or other apertures through the refractory of the roof 17 adapted for delivering gas into the furnace. Alternatively or in addition, the gas injection ports may be lances such as oxygen lances. In one alternative, the gas injection ports 29 are slots through the roof refractory extending across at least a portion of the width of the furnace. A flow of diluted oxygen gas, such as oxygen and carbon dioxide, may be delivered into the hearth furnace through the gas injection ports 29 to control flame temperature and heat the furnace to a temperature sufficient to at least partially reduce the reducible material as discussed below.

Alternatively or additionally, the hearth furnace may comprise a plurality of gas injection ports positioned along the sides of the furnace adapted to deliver a flow of fuel into the furnace above the reducible material. We have found it beneficial to place the injection ports directed to reduce impingement of oxygen onto the materials on the hearth.

The burners 16 may be oxy-fuel burners. Alternatively or additionally, one or more burners may be fuel-air burners.

The primary flow of gases from the burners 16 toward the entry end of the furnace may be selected from a group consisting of combustible fuel, oxygen and carbon dioxide, oxygen and flue gas, oxygen and air, or a combination thereof delivered into the hearth furnace at least through the burner to heat the furnace to a temperature sufficient to at least partially reduce the reducible material. The flow of gases may include a flow of diluted oxygen gas delivered adjacent the discharge end of the furnace and/or gas injection ports along the furnace directing a flow of gases toward the entry end. The stream of diluted oxygen gas may have an oxygen concentration as desired for combustion of fuel and volatiles, to control flame temperature and flame stability, and inhibit damage to the refractories in the furnace. The stream of diluted oxygen gas may be oxygen diluted with carbon dioxide, air or nitrogen, and/or process flue gas from the exhaust stack or some other source. As used herein, a flow of diluted oxygen gas may have an oxygen concentration as desired in a range from air to nearly pure oxygen. The stream of diluted oxygen gas is such as to provide the desired flame temperature and flame stability and heat to the furnace, and to provide a gas flow of appropriate mass to conduct heat in and through the furnace. If a sequestration of carbon dioxide is desired from the exhaust stack gases, then the dilution of the oxygen should be with carbon dioxide or flue gas relatively high in carbon dioxide. The stream of diluted oxygen gas may be preheated to deliver more heat to the furnace through the flow of gases into the furnace.

We have found that the system performance improves when the axial velocity, or the velocity of the flow of gas in the longitudinal direction along the furnace, of the primary flow of gases through the conversion zone 13 and fusion zone 14 is greater than about 4 feet per second near the hearth. In one alternative, the axial velocity is between about 5 feet per second and 10 feet per second near the hearth. In yet another alternative, the axial velocity is between about 4 feet per second and 15 feet per second near the hearth. Higher axial velocities may be may be achieved with consideration of the materials on the hearth to reduce entrainment of solids from the hearth into the flow of gasses. Prior furnaces provided localized movement of gas at increased velocities, for example, near burner ports, but could not provide increased velocity along the length of the furnace.

The axial flow of gasses through the furnace may be increased by providing a roof restriction 50 decreasing the cross-sectional area in one or more locations along the furnace. In the configuration shown in FIGS. 5 through 7, the furnace 10 includes a plurality of roof restrictions 50 along the furnace. The gas flow velocity may also be increased by one or more factors, including burner orientation, secondary oxygen injection, location of oxygen ports, increasing or decreasing dilution of oxygen with nitrogen or carbon dioxide along the furnace, and secondary oxygen temperature.

Each roof restriction 50 includes a leading transition portion 52 and a trailing transition portion 54 in the direction of gas flow. The leading transition portion 52 extends from the roof 17 to the roof restriction 50 having a slope to direct to the flow of gas toward the restriction, and may act as a nozzle. The trailing transition portion 54 extends from the roof restriction 50 to the roof 17. The height of the roof 17 may be greater on the trailing side of roof restriction 50 than on the leading side.

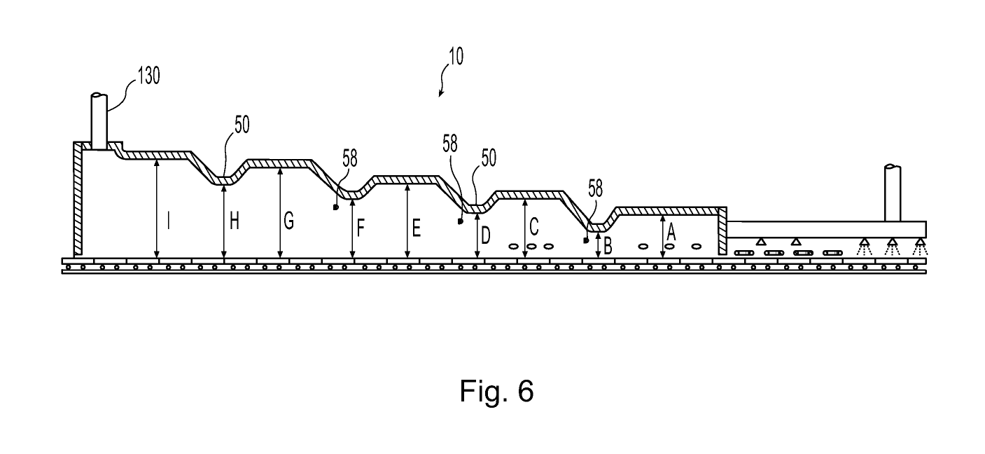

In one example shown in FIG. 6, the heights of the furnace are tabulated in TABLE 1. In this example, the furnace contemplated is 100 feet in length and prepared for an air-fuel based system.

TABLE 1
Furnace Roof Heights for EXAMPLE shownin FIG. 6

| FIG. 6 Location | Height (inch) |
|---|---|
| A | 38 |
| B | 16 |
| C | 58 |
| D | 40 |
| E | 68 |
| F | 50 |
| G | 78 |
| H | 60 |
| I | 84 |

Other furnace configurations are contemplated to provide axial velocity of the primary flow of gases through the reduction zone and fusion zones between about 4 feet per second and 15 feet per second near the hearth. The desired height of the roof restriction 50 may vary with the gas selected. For example, a flow of gas having a high concentration of oxygen may use a roof height generally lower than when using a gas flow of a dilute oxygen stream, such as oxygen enriched air.

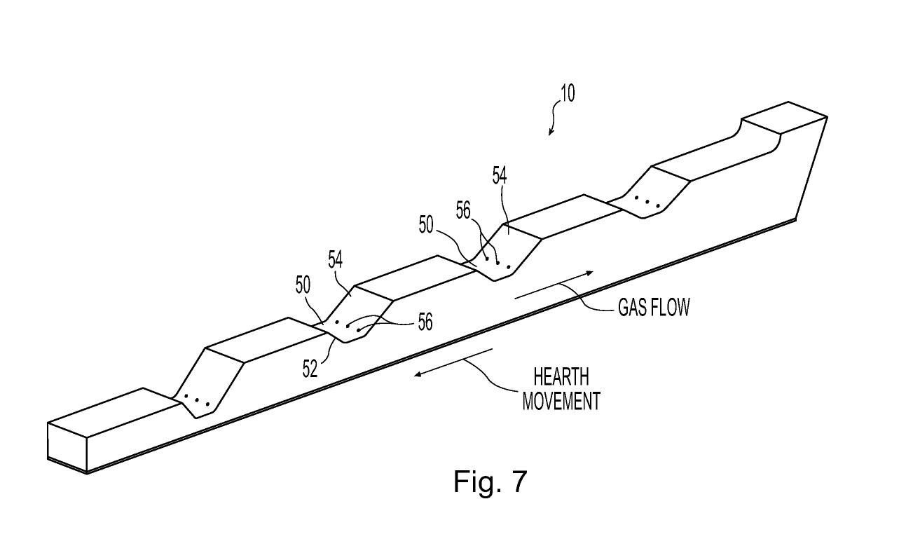

As shown in FIGS. 5 through 7, the roof restrictions 50 provide a restriction to increase the gas velocity as the gas passes beneath the restriction 50. To maintain the gas velocity as the gas passes by the restriction, gas injection ports 56 may be provided in the trailing transition portion 54 as shown in FIG. 7 for injecting gas in an approximately axial or longitudinal direction. The gas injection ports 56 may be a gas port configuration such as shown in FIG. 9 having diverters 98 adapted to direct oxygen or gas mixtures including oxygen in a desired direction. Alternatively, the gas injection ports 56 may be an oxygen lance or other gas port adapted to provide oxygen or gas mixtures including oxygen into the furnace. Alternatively or additionally, burners 16 may be provided in one or more trailing transition portions 54 along the furnace.

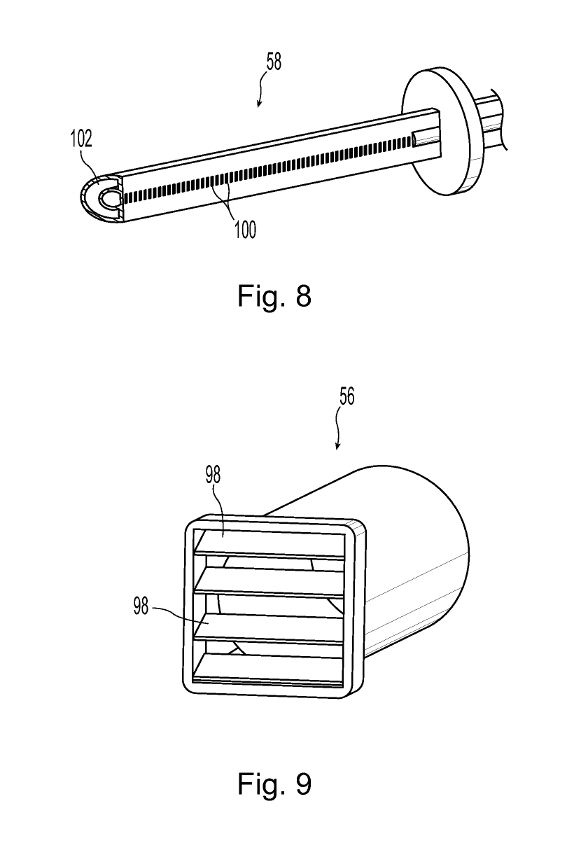

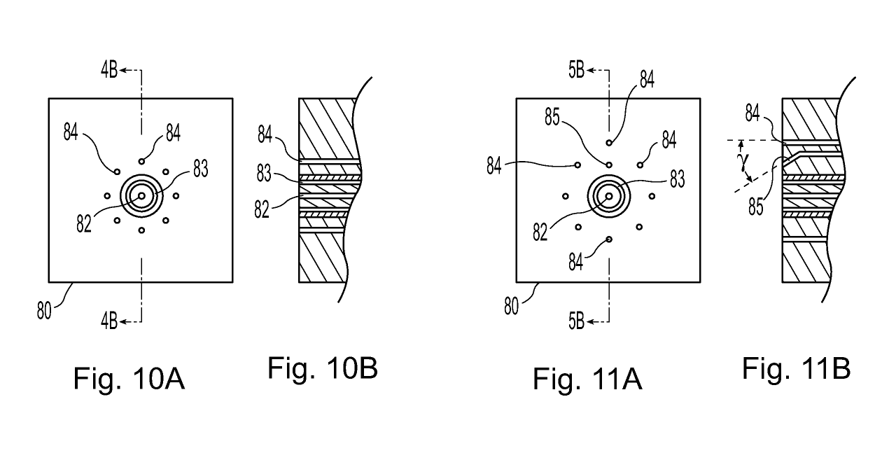

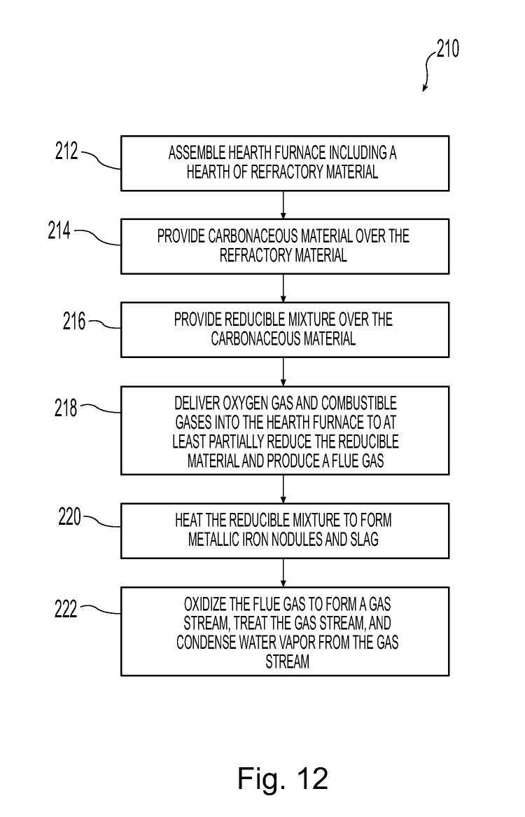

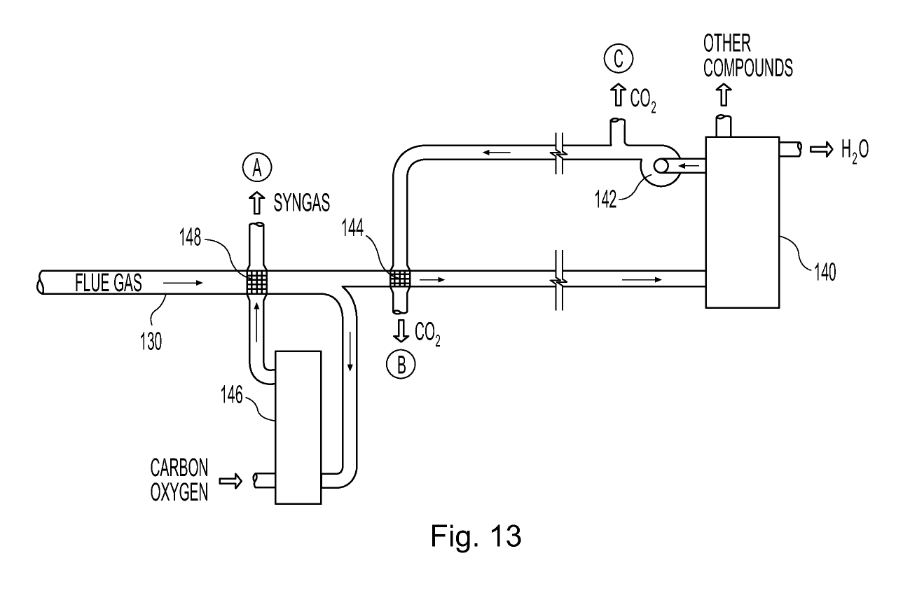

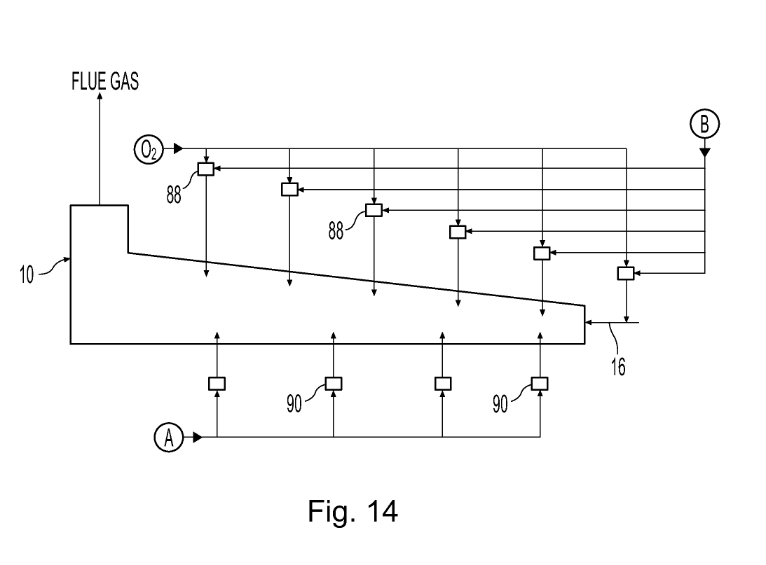

The gas may be injected into the furnace using traverse pipe injectors 58 as shown in FIG. 8. As shown in FIG. 8, the traverse pipe injectors may be adapted to be positioned across the width of the furnace, such as beneath the roof restriction 50 as shown in FIG. 6 for injecting gas in an approximately axial direction along the furnace. The traverse pipe injectors may include apertures 100 for directing the oxygen or gas mixtures including oxygen in a direction in an axial direction along the furnace. Additionally, the traverse pipe injectors 58 may include a cooling passage 102 to reduce the temperature of the pipe injector in the furnace.

In an alternative such as shown in FIG. 5, burners 16 may be positioned along the furnace. In one example using oxy-fuel burners, the burners in the fusion zone 14 may be configured to deliver a substoichiometric amount of oxygen, or less oxygen than needed for complete combustion of the fuel through the burner. Similarly, burners in the reduction and drying zones may deliver a stoichiometric or superstoichiometric amount of oxygen to maintain flame temperatures and consume volatiles in the furnace as desired.

Referring to block 114 of FIG. 1, the preparation of the reducible material of iron bearing material and carbonaceous material for processing by the hearth furnace is illustrated. A hearth layer is provided on the hearth 20 that includes at least one carbonaceous material. The carbonaceous material may be any carbon-containing material suitable for use as a reductant with the iron-bearing material. The hearth material layer includes coke, char, other carbonaceous material, or mixtures thereof. For example, anthracite coal, bituminous coal, sub-bituminous coal, coke, coke breeze, or char materials may be used for the hearth material layer. We have found that certain bituminous and sub-bituminous (e.g. Jim Walter Coal and Powder River Basin) coals may be used in mixtures with anthracite coal, coke, coke breeze, graphite, or char materials.

The hearth material layer may comprise a mixture of finely divided coal and a material selected from the group of coke, char, and other carbonaceous material found to be beneficial to increase the efficiency of iron reduction. The coal particles may be a mixture of different coals such as non-coking coal, non-caking coal, sub-bituminous coal, or lignite. The hearth material layer may, for example, include Powder River Basin (“PRB”) coal and/or char. Additionally, although up to one hundred percent coal is contemplated for use as a hearth material layer, in some embodiments the finely divided coal may comprise up to twenty-five percent (25%) and may be mixed with coke, char, anthracite coal, or other low-volatile carbonaceous material, or mixtures thereof. In other embodiments, up to fifty percent (50%) of the hearth material layer may comprise coal, or up to seventy-five percent (75%) of the hearth material layer may comprise coal, with the remaining portion coke, char, other low-volatile carbonaceous materials, or mixtures thereof. The balance will usually be determined by the amount of volatiles desired in the reduction process and the furnace.

Using coal in the hearth material layer provides volatiles to the furnace to be combusted providing heat for the process. The volatiles can be directly burned near the location of their volatilization from the coal, or may be communicated to a different location in the furnace to be burned at a more desirable location. Regardless of the location in the hearth furnace, the volatiles can be consumed to at least partially heat the reducible material. The carbonaceous material in the hearth layer also may provide a reductant source for reducing the iron bearing material in the furnace while still protecting the hearth refractories.

The hearth material layer is of a thickness sufficient to prevent slag from penetrating the hearth material layer and contacting the refractory material of the hearth 20. For example, the carbonaceous material may be ground or pulverized to an extent such that it is fine enough to prevent the slag from such penetration, but typically not so fine as to create excess ash. As recognized by one skilled in the art, contact of slag with the hearth 20 during the reduction process may produce undesirable damage to the refractory material of hearth 20. A suitable particle size for the carbonaceous material of the hearth layer is less than 4 mesh and desirably between 4 and 100 mesh, with a reasonable hearth layer thickness about ½ inch or more effective protection for the hearth 20 from penetration of the slag and metallic iron during processing. Carbonaceous material less than 100 mesh may be avoided because it is generally high in ash, and resulting in entrained dust that is difficult to handle in commercial operations. The mesh sizes of the discrete particles are measured by Tyler Mesh Size for the measurements given herein.

As shown in block 116 of FIG. 1, the reducible material is positioned over the hearth cars 21 above at least a portion of the hearth material layer, typically prior to entering the furnace. The reducible material is generally in the form of a mixture of finely divided iron ore, or other iron oxide bearing material, and a reducing carbonaceous material such as coke, char, anthracite coal, or non-caking bituminous and sub-bituminous coal. The reducible material is in mixtures of finely divided iron bearing material that are formed into compacts. The compacts may be briquettes, balls, or mounds preformed or formed in situ on the hearth cars 21 so that the mixtures of reducible material are presented to the furnace 10 in discrete portions.

The iron-bearing material may include any material capable of being formed into metallic iron nodules via method 110 for producing metallic iron nodules as described with reference to FIG. 1. The reducible iron bearing material may contain at least a material selected from the group consisting of mill scale, magnetite, hematite, and combinations thereof. For example, the iron-bearing material may include iron oxide material, iron ore concentrate, taconite pellets, recyclable iron-bearing material, pellet plant wastes and pellet screened fines. Further, such pellet plant wastes and pellet screened fines may include a substantial quantity of hematite. In addition, such iron-bearing material may include magnetite concentrates, oxidized iron ores, steel plant wastes, red mud from bauxite processing, titanium-bearing iron sands and ilmenites, manganiferous iron ores, alumina plant wastes, or nickel-bearing oxidic iron ores. Also, less expensive iron ores high in silica may be used. Other reducible iron bearing materials may also be used for making the reducible material for producing metallic iron nodules used in the processes described herein to produce metallic iron nodules. For example, nickel-bearing laterites and garnierite ores for ferronickel nodules, or titanium bearing iron oxides such as ilmenite that can be made into metallic titanium iron nodules (while producing a titania rich slag).

In one alternative, the reducible material may contain mill scale containing more than 55% by weight FeO and FeO equivalent, such as disclosed in International Patent Application PCT/US2010/021790, filed Jan. 22, 2010, incorporated herein by reference.

The iron-bearing material may be finely-ground or otherwise physically reduced in particle size. The particle size of the mill scale or mixture of mill scale and similar metallurgical waste may be at least 80% less than 10 mesh. Alternatively, the iron-bearing metallurgical waste may be of a particle size of at least 80% less than 14 mesh. In one alternative, the iron-bearing material may be ground to less than 65 mesh (i.e., −65 mesh) or less than 100 mesh (i.e., −100 mesh) in size for processing according to the disclosed method of making metallic iron nodules. Larger size particles, however, of iron-bearing material may also be used. For example, pellet screened fines and pellet plant wastes are generally approximately 3 mesh (about 0.25 inches) in average size. Such material may be used directly, or may be reduced in particle size to increase surface contact of carbonaceous reductant with the iron bearing material during processing. A smaller particle size tends to reduce fusion time in the present method.

Various carbonaceous materials may be used in providing the reducible material of reducing material and reducible iron-bearing material. The reducing material may contain at least a material selected from the group consisting of, anthracite coal, coke, char, bituminous coal and sub-bituminous coal such as Jim Walter coal and Powdered River Basin coal, or combinations thereof. For example, eastern anthracite and bituminous non-caking coals may be used as the carbonaceous reductant in at least one embodiment. However, sub-bituminous non-caking coal may also be used, such as PRB coal. Sub-bituminous coal may be useful in some geographical regions, such as on the Iron Range in northern Minnesota, as such coals are more readily accessible with the rail transportation systems already in place and in some cases are lower in cost and lower in sulfur levels. As such, western sub-bituminous coals may be used in one or more embodiments of the present method as described herein. Alternatively, or in addition, the sub-bituminous coals may be carbonized, such as up to about 1650° F. (about 900° C.), prior to its use. Other coals may be provided, such as low sulfur bituminous coal from Elkhorn seams from eastern Kentucky, as described below. In any case, the carbonaceous material in the reducible material may contain an amount of sulfur in a range from about 0.2% to about 1.5%, and more typically, in the range of 0.5% to 0.8%.

The amount of reducing material in the mixture with iron bearing material to form the reducible material will depend on the stoichiometric quantity necessary for complete metallic reduction of the iron in the reducing reaction in the furnace. Such a quantity may vary depending upon the percentage of iron in the iron-bearing material, the reducing material and the furnace used, as well as the furnace atmosphere in which the reducing reaction takes place. In some embodiments, where the iron bearing material is hematite or magnetite or mixtures thereof, the carbonaceous material in the reducible material may be between 70 and 90% of the stoichiometric amount to complete reduction of the iron in the iron-bearing material. Where the iron bearing material in the reducible material is mill scale or the like with high levels of FeO, the reducible material may include an amount of carbonaceous material that is between 80 and 110% of the stoichiometric amount needed to reduce the iron-bearing material to metallic iron. In other alternative embodiments where mill scale or the like is used for the iron bearing material, the quantity of reducing material necessary to carry out the reduction of the iron-bearing material is between about 85 percent and 105 percent of the stoichiometric quantity of reducing material needed for carrying out the reduction to metallize the iron, and may be between 90 percent and 100 percent.

In an alternative embodiment of the present method, a layer containing coarse carbonaceous material may also be provided over at least a portion of the layer of reducible material. The coarse carbonaceous material of the overlayer may have an average particle size greater than an average particle size of the hearth layer carbonaceous material. In addition or alternatively, the overlayer of coarse carbonaceous material may include discrete particles having a size greater than about 4 mesh or about 6 mesh, and in some embodiments, the overlayer of coarse carbonaceous material may have discrete particles with a size between about 4 mesh or 6 mesh and about ½ inch (about 12.7 mm). There may be of course some particles in the coarse carbonaceous material less than 4 mesh or 6 mesh in size in commercially made products, but the substantial majority of the discrete particles will be greater than 4 mesh or 6 mesh where a coarse carbonaceous material of particle size greater than 4 mesh or 6 mesh is desired. Finer particles of carbonaceous material that may be present in some commercially available compositions may be included but less desired. The coarse carbonaceous material may be selected from the group consisting of anthracite coal, bituminous coal, sub-bituminous coal such as PRB coal, coke, char, and mixtures of two or more thereof.

The conversion zone and fusion zone may be heated to a temperature sufficient to reduce the reducible material by heat from the oxy-fuel burners 16 and the delivery of oxygen gas and carbon dioxide through the gas injection ports 29 and/or the oxy-fuel burners 16. The flow of oxygen gas and carbon dioxide may be delivered at a plurality of locations along the furnace to aid in the combustion of volatiles evolving from the carbonaceous materials as well as the carbonaceous material in the hearth furnace providing additional heating to the furnace. The oxygen gas may be pure oxygen, which for purposes of this disclosure, includes commercially available oxygen gas having a concentration of at least 95% oxygen. The flow of diluted oxygen gas through the gas injection ports 29 along the conversion zone 13 and fusion zone 14 may be between about 10% and 40% oxygen gas by volume, and may be between about 15% and 35% oxygen gas by volume. Alternatively, the flow of diluted oxygen gas may be between about 25% and 40% oxygen gas by volume. In yet another alternative, the flow of diluted oxygen gas may include an oxygen concentration of between about 35% and 50%, or greater by volume. The stream of diluted oxygen gas may be oxygen diluted with carbon dioxide, air or nitrogen, and/or process flue gas from the exhaust stack or some other source. The stream of diluted oxygen gas is such as to provide the desired flame temperature and flame stability and heat to the furnace, and to provide a gas flow of appropriate mass to conduct heat in and through the furnace. The stream of diluted oxygen gas may be varied by an amount of diluent such as carbon dioxide to regulate the oxygen concentration in the furnace.

As shown in FIGS. 2 through 4 and 9, the flow of diluted oxygen gas may be delivered into the furnace through gas injection ports 29 or through oxygen lances positioned in the roof 17 of the furnace housing 11 in both the conversion zone 13 and the fusion zone 14. The gas injection ports or lances may be positioned to deliver a flow of gas downward from the roof 17 into the interior of the furnace. Alternatively, the gas injection ports or lances may extend into the furnace within about 18 inches (45.7 cm) downward from the roof 17 into the interior of the furnace. Alternatively or additionally, the gas injection ports 29 may be positioned in the sidewalls 18. In either embodiment, the flow of oxygen gas is delivered above the primary flow of gases between the oxy-fuel burner 16 and the exhaust stack 130. The flow of oxygen gas and carbon dioxide may be also delivered to the drying/preheating zone 12 in order to regulate temperature.

Referring to block 118 of FIG. 1, the oxygen gas may be delivered into the conversion zone 13 and fusion zone 14 at a ratio of at least 0.7:1 pounds of oxygen per pound of iron in the reducible iron bearing material in the conversion zone and fusion zone of the furnace. In other alternate embodiments, the ratio of pounds of oxygen gas per pound of iron in the reducible iron bearing material in the furnace may be at least 0.8:1, at least 0.9:1, at least 1:1, at least 1.2:1, at least 1.5:1, or at least 1.7:1, depending upon the composition of the carbonaceous materials in the hearth layer, in the reducible material, and, if provided, in the coarse carbonaceous overlayer. It should be noted that although the ratio of pounds of oxygen gas per pound of iron in the reducible iron bearing material in the conversion zone 13 and fusion zone 14 of the furnace may be controlled as desired, the particular ratio within a particular volume of the furnace may be higher or lower depending upon the concentration of other gases within that particular volume. As used herein, the ratio of pounds of oxygen gas to pounds of iron in the reducible iron bearing material is based on the overall amount of oxygen gas delivered to the furnace, and the ratio of pounds of oxygen gas to pounds of iron in the reducible material may be more or less than the overall ratio in any particular location along the length of the furnace as described below.

The flow of diluted oxygen gas into the furnace may be regulated along the length of the conversion zone 13 and fusion zone 14 of the furnace 10 according to the concentration of carbon monoxide and volatiles fluidized from the reducible materials to more efficiently oxidize the carbon monoxide and combust the volatiles. The fluidization of volatiles is dependent upon the composition of the carbonaceous materials charged into the furnace and the temperature profile of the furnace. A higher flow of oxygen gas may be directed to where higher levels of carbon monoxide are found along the length of the conversion zone and fusion zone, such as toward the beginning of the conversion zone. Less oxygen gas may then be directed to where lower levels of carbon dioxide are present within the furnace, such as the downstream end of the fusion zone. The amount of oxygen gas delivered to the furnace may be varied by increasing or decreasing the flow of diluted oxygen gas, or controlling the amount of oxygen in the stream of diluted oxygen gas, or a combination of both.

By increasing the amount of carbon monoxide and hydrogen gas oxidized in the furnace 10, the resultant flue gas from the exhaust stack 130 of the furnace has a reduced concentration of carbon monoxide and hydrogen and increased concentrations of carbon dioxide and water vapor, as compared to the flue gas generated when oxygen gas is delivered to the conversion zone 13 and fusion zone 14 of the furnace 10 in more even concentration along the furnace. Decreasing the carbon monoxide and hydrogen content in the flue gas results in reducing if not eliminating the need for a thermal-oxidizer in the flue gas stream to oxidize the flue gas, as described below with reference to FIG. 7. In the furnace, as the hydrogen gas, carbon monoxide and other volatiles in the conversion zone 13 and fusion zone 14 flow toward the exhaust stack 130, they are oxidized by the increased flow of oxygen prior to flowing into the exhaust stack. The flow of oxygen gas may be varied along the furnace to provide for oxidization of the carbon monoxide and hydrogen in the furnace atmosphere.

While the oxygen gas may be delivered into the conversion zone 13 and fusion zone 14 of the furnace 10 at a desired ratio of pounds of oxygen per pound of iron in the reducible iron bearing material in the conversion zone and fusion zone, the flow of diluted oxygen gas may be varied along the length of the furnace. The flow of oxygen gas to certain points along the furnace may cause the ratio of oxygen gas to iron in reducible iron bearing material to be higher than said ratio to the conversion zone 13 and fusion zone 14 overall. For example, the ratio of oxygen gas to iron in the reducible material delivered at the upstream end of the conversion zone 13 may be higher than said overall ratio of oxygen gas to iron in the reducible material delivered to the conversion zone 13 and fusion zone 14. Additionally or alternatively, the flow of oxygen gas may be higher in certain other parts of the furnace than the overall ratio of oxygen gas to iron in the reducible material, such as near the downstream end of the conversion zone 13 and the upstream end of the fusion zone 14, where higher concentrations of hydrogen gas and carbon monoxide are likely found. The flow of oxygen gas may be lower in certain other parts of the furnace, such as near the downstream end of the fusion zone 14, where excess oxygen may not be desired. Again, by this regulation of oxygen gas, the hydrogen gas and carbon monoxide are more likely oxidized in the furnace, thereby increasing the concentration of water vapor and carbon dioxide in the flue gas while decreasing the concentration of hydrogen and carbon monoxide in the flue gas.

The oxy-fuel burners 16 may also be fired with a fuel, for example natural gas, methane, propane, fuel oil, and coal, at the start of a campaign to heat each zone of the furnace to sufficient temperature, for example, at least about 2350° F. (about 1290° C.) in the conversion zone and at least about 2550° F. (1400° C.) in the fusion zone. Subsequently, the oxygen gas may be continuously delivered into the conversion and fusion zones through the oxygen ports 29 and/or through the oxy-fuel burners 16 at a rate sufficient to maintain the zones at the temperatures to reduce reducible material in the furnace and produce metallic iron nodules. Note the oxygen gas may also be delivered during start up to assist in heating the zones of the furnace to desired temperatures to reduce the reducible material in the furnace and produce metallic iron nodules. In some embodiments, once the rate of oxygen gas delivery is sufficient to maintain the desired temperature through combustion of the evolved volatiles, carbonaceous material from the furnace charge, and reductant gases delivered to the furnace, the delivery of the combustible fuels through the oxy-fuel burners may be substantially reduced and may be shut off to avoid fuel usage and more efficiently operate the furnace to produce metallic iron nodules in accordance with the present method.

In any case, the metallic iron nodules, slag and related material are cooled in cooling zone 15 from its formation temperature in the fusion zone 14 to a temperature at which the metallic iron nodules can be separated and the slag and related materials processed. This temperature is generally below 800° F. (425° C.) and may be below about 550° F. (290° C.). Alternatively, the temperature of the material on the moving hearth 30 after the cooling zone 15 may be between about 300 to 600° F. (150-315° C.). The cooling can be achieved by injection of nitrogen or carbon dioxide through nozzles 96 in the roofs and/or side walls of the furnace housing or external to the furnace housing. Alternatively or in addition, the cooling step may be accomplished or completed outside the furnace housing 11 by water spray 93 in the cooling zone 15, where provisions are made for water handling within the system. Alternatively or additionally, a system of coolant tubes 94 may be positioned over the moving hearth 20 as shown in FIG. 2. A vent hood 92 may be positioned above the moving hearth 20 to remove evaporated water and other fluidized materials that come off of the hearth during the cooling Optionally, a horizontal baffle 63 may also be positioned adjacent the baffle 60 above the moving hearth 20 in the cooling zone 15 to inhibit fluid flow between the fusion zone 14 and the cooling zone as shown in FIG. 4.

FIG. 7 shows a block diagram of an illustrative embodiment of a method 210 to produce metallic iron nodules, which may be implemented using one of the embodiments of the hearth furnaces previously described with reference to FIGS. 2 through 4. In certain applications, sequestration of carbon dioxide from the system may be desired to reduce emissions of carbon dioxide. In this alternative, the dilution of oxygen with carbon dioxide or flue gas relatively high in carbon dioxide may be used, and the carbon dioxide sequestered from the exhaust stack gases or a portion thereof.

In the present method with an oxygen and carbon dioxide gas stream delivered to the furnace, stack emissions produced with the present method are sufficiently high in carbon dioxide that a thermal oxidizer may not be necessary in the flue gas stream. By reducing the moisture and further cleaning the flue gas stream exhausted through the stack 130, a gas stream can be produced having at least 90% carbon dioxide, and may be at least 95% carbon dioxide. Referring to block 218 of FIG. 7, oxygen gas and optionally, combustible fuels, are delivered to the conversion zone 13 and the fusion zone 14 such that the conversion zone is heated to a temperature sufficient to at least partially reduce the reducible material and the fusion zone is heated to a temperature sufficient to at least partially reduce the reducible material to metallic iron nodules. The flue gas produced may have a composition of at least 25% carbon dioxide. In addition to carbon dioxide, the flue gas may include carbon monoxide, hydrogen, water vapor, oxygen, and methane. For example, the flue gas may contain about 40% CO₂, about 42% H₂O, about 10% CO, about 5% H₂, and about 3% other gases. In an oxygen-fueled system, the flue gas stream is typically low in nitrogen gas. The flue gas may also include, in fluid form, sulfur-containing and halogen-containing compounds.

With reference to block 222 of FIG. 7 and FIG. 8, at least a portion of the flue gas may be directed to the scrubber 140 for processing. The flue gas may be processed to produce a gas stream having a composition of at least 90% or 95% carbon dioxide by oxidizing carbon monoxide and hydrogen treating the gas stream to remove at least one of sulfur-containing and halogen-containing compounds, and condensing water vapor from the gas stream.

The water vapor may be removed from the gas stream by cooling to a temperature at which any water vapor present in the gas stream would condense, for example at a temperature below about 212° F. (about 100° C.) at atmospheric pressure. The remaining gas stream contains a high concentration of CO₂, and may exit the scrubber 140 between about 100° F. and 500° F. (between about 40° C. and 260° C.). Alternatively, the gas stream may be cooled to a temperature of about 80° F. (27° C.). A blower 142 may be provided to convey the CO₂ stream cooled to a temperature suitable for the blower 142 as desired. The cooled carbon dioxide stream is shown as C in FIG. 8. At least a portion of the cooled CO₂ stream may be delivered into the cooling zone 15 through nozzles 96 to provide cooling of the metallic iron and carbonaceous material.

As sulfur-containing and halogen-containing compounds are not desirable in the carbon dioxide gas stream, these compounds may also be removed from the gas stream in the scrubber. The gas stream may be treated using lime and/or limestone, which may react with sulfur dioxide present in the gas stream to form calcium sulfate dihydrate (CaSO₄.2H₂O), also known as gypsum.

It is to be understood that the gas stream may be cooled to condense the water vapor before or after the gas stream is treated with lime and/or limestone in order to remove sulfur-containing and/or halogen-containing compounds.

Once the gas stream has been treated and water has been condensed therefrom, a gas stream containing at least 90% or 95% carbon dioxide remains. This gas stream having a high carbon dioxide concentration is a salable product or may be subsequently processed. The cooled carbon dioxide stream, shown as C in FIG. 8, may be condensed into a liquid, precipitated into a carbonate, or transported through a pipeline for use, sale, or disposal at a location apart from the metallic iron nodule production location. For example, the captured carbon dioxide may be injected into a mature oil well to enhance oil recovery. In another alternative, the carbon dioxide may be injected into geological formations such as gas fields, saline formations, unminable coal seams, and saline-filled basalt formations. In this method, known as sequestration, the carbon dioxide can be chemically reacted to produce stable carbonates, thereby reducing the amount of carbon dioxide emitted into the atmosphere from production of metallic iron nodules. In one embodiment, a majority of the CO₂ gas stream is directed to sequestration, while a minority is retained for use in the hearth furnace system.

The CO₂ stream may be utilized in the furnace 10 in producing iron nodules by the present methods. The CO₂ stream may be heated and directed into the furnace housing 11 as desired. The flow of oxygen gas and carbon dioxide may include carbon dioxide from the gas stream processed from the flue gas. Additionally, the carbon dioxide may be preheated before delivery to the furnace. The CO₂ may be directed through a heat exchanger 144. At least a portion of the flue gas may be directed through the heat exchanger 144 to transfer heat from the flue gas to the carbon dioxide to recover heat from the flue gas exiting the furnace 10. The heated CO₂ stream, shown as B in FIG. 8, may be delivered with oxygen gas to heat the drying/preheating zone, the conversion zone, and/or the fusion zone. Alternatively, the CO₂ stream may be delivered to the furnace through or adjacent the oxy-burners 16 to regulate the flame temperatures as discussed below. Using these techniques, the emission of CO₂ gas into the ambient atmosphere may be reduced.

Lower flame temperatures may be used to decrease the wear of burner components exposed to excessive heat, increasing burner life and reducing maintenance. Flame temperatures are controlled by the concentration of oxygen in the stream. Flame temperature increases with increasing oxygen concentration. The adiabatic flame temperature for an oxy-fuel burner operating on pure oxygen and methane is approximately 5000° F. (2760° C.), while the adiabatic flame temperature for an oxy-fuel burner operating on a 30% oxygen/70% carbon dioxide mixture approaches that of an air/natural gas flame at about 3800° F. (about 2090° C.). Since flame temperature is dependent on the oxygen concentration, the delivery of oxygen to the oxy-fuel burner may be diluted with carbon dioxide to adjust the flame temperature as desired. Diluting the oxygen stream with carbon dioxide reduces the relative concentrations of fuel and oxidant thereby decreasing flame temperature. Additionally, dilution of oxygen with carbon dioxide enables recovery of a portion of the waste heat to the furnace, such as by direct transfer of gases, or using heat exchange with hot flue gases. As discussed above, the CO₂ may be directed through the heat exchanger 144 before such mixing with the oxygen to recover heat from the flue gas exiting the furnace 10. The CO₂ may be preheated to about 750° F. (about 400° C.) in the heat exchanger 144. Alternately, the CO₂ may be preheated to between about 400° F. (about 200° C.) and 1500° F. (about 810° C.) in the heat exchanger 144.

Alternately or in addition, at least a portion of the flue gas may be directed into a gasifier 146. The gasifier 146 may be utilized to process carbon-containing materials such as by-products from the iron reduction process, including ash, char and coal powders, slag, and other waste materials. The flue gas may be processed in the gasifier 146 with injected oxygen and carbon-containing materials to produce a mixture of CO and H₂, or syn-gas. The syn-gas stream, shown as A in FIG. 8, may be heated in a heat exchanger 148 and then directed into the furnace 10 as a reductant and as a fuel. At least a portion of the flue gas may be directed through the heat exchanger 148 to transfer heat from the flue gas stream into the syn-gas stream. The syn-gas may be preheated to about 1000° F. (about 540° C.) in the heat exchanger 148. Alternately, the syn-gas may be preheated to between about 400° F. (about 200° C.) and 1200° F. (about 650° C.) in the heat exchanger 148. In yet another alternative, the gasifier may produce a syn-gas stream at a temperature sufficiently elevated that pre-heating is not needed, such as up to 1650° F. or higher. By processing waste materials the gasifier 146 may further improve the overall efficiency of the method of producing metallic iron.

Ports 74 may be positioned capable of injecting fuel or volatiles or other gases into the furnace above the reducible material. A plurality of ports 74 may be positioned along the furnace for delivery of fuel above the reducible material at a plurality of locations along the furnace. The delivery of fuel or volatiles or other gases may provide heat to regions of the furnace beyond the reach of direct radiation from the burner flame. The fuel delivered through the ports 74 may be syn-gas, shown as A in FIG. 8, from the gasifier 146 as discussed above. Alternatively, the fuel delivered through the ports 74 above the reducible material may be syn-gas, methane, propane, natural gas or a combination of two or more thereof. The fuel may be preheated in the heat exchanger 148. Alternately, the fuel may be externally preheated, preheated by a regenerative heat exchange on the furnace wall, or delivered cold. Preheating the gases delivered through ports 74 using a waste heat recovery may be useful in increasing the efficiency of the system.

As noted, cooling may begin in the furnace housing 11. In one alternative, a fuel or reductant gas may be delivered over the reduced iron material in the fusion zone 14 through gas ports 74 adjacent the discharge end of the furnace. The flow of reductant over the reduced iron bearing material may begin cooling the reduced iron bearing material as it exits the fusion zone, and the reductant provides additional fuel to the fusion zone to maintain temperatures as desired.

As discussed above, the flow of oxygen gas may be regulated along the length of the furnace according to the concentration of carbon monoxide and volatiles fluidized from the reducible materials to more efficiently oxidize the carbon monoxide and combust the volatiles. A higher flow of oxygen gas may be directed to where higher levels of carbon monoxide are found along the length of the furnace, such as toward the beginning of the conversion zone. Less oxygen gas may then be directed to where lower levels of carbon monoxide are present within the furnace, such as the downstream end of the fusion zone. In any event, oxygen gas may be diluted with carbon dioxide to regulate flame temperatures and furnace temperatures as desired.

Oxygen gas and preheated carbon dioxide may be mixed and delivered into the furnace through the roof injection lances or gas injection ports 29 to maintain furnace temperatures as desired. The delivery of carbon dioxide and oxygen gas through the gas injection ports 29 may be regulated by controlling the flow of oxygen gas and carbon dioxide, the oxygen concentration, and the preheat temperature carbon dioxide.

A metering system may be provided capable of regulating the amount of oxygen and carbon dioxide delivered into the furnace. As shown in FIG. 9, a metering device 88 may be operatively connected to one or more gas injection ports 29 capable of increasing or decreasing the flow to the gas injection port. The metering device 88 may be configured to maintain a desired ratio of carbon dioxide to oxygen gas, and the metering device 88 increasing and decreasing the flow of the carbon dioxide/oxygen gas mixture to increase or decrease the flow of oxygen gas to the furnace. In an alternative configuration, the metering device 88 may be configured to maintain a desired flow of carbon dioxide, and the metering device increasing and decreasing the flow of oxygen gas to increase or decrease the flow of oxygen gas to the furnace. In yet another alternative, the metering device 88 may be configured to increase or decrease the flow of carbon dioxide gas and increase or decrease the flow of oxygen gas independently of one another. In any event, the amount of oxygen gas delivered to the furnace may be selected based on the delivery location in the furnace. For example, the flow of carbon dioxide and oxygen gas may include between about 30% and 40% oxygen by volume in the drying/preheating zone 12, between about 20% and 30% by volume in the conversion zone, and less than 20% by volume in the fusion zone.

Alternatively or in addition, the metering system and metering device 88 may be adapted to deliver air or nitrogen, flue gas, or other gas to dilute the oxygen gas as desired.

The metering device 88 may increase or decrease the flow of oxygen gas to the furnace responsive to furnace temperatures in the furnace at desired locations. A temperature sensor may be provided in the furnace at a desired location to sense the temperature of the furnace at the desired location. Then, the flow of oxygen gas may be increased or decreased as desired responsive to the sensed temperature.

As shown in FIG. 9, one or more fuel metering valves 90 may be operatively connected to one or more gas stream ports 74. The fuel metering valve 90 may be provided adapted to increase or decrease the flow of fuel, volatiles, or other gases through the gas stream ports 74. The flow of fuel or volatiles or other gases through the fuel metering valve 90 into the furnace above the reducible material through ports 74 along the furnace may be increased or decreased as desired responsive to the sensed temperature.

A gas analyzing sensor may be positioned capable of analyzing the flue gas from the exhaust stack 130. The gas analyzing sensor may be provided to determine the concentration of oxygen in the flue gas. The flow of oxygen gas into the conversion zone 13 and fusion zone 14 may be increased or decreased as desired responsive to the sensed oxygen concentration. Alternatively or in addition, the flow of fuel or volatiles or other gases into the furnace above the reducible material through ports 74 along the furnace may be increased or decreased as desired responsive to the sensed oxygen concentration. Alternatively or in addition, the gas analyzing sensor may be provided to determine the concentration of carbon monoxide in the flue gas. Then, the flow of oxygen gas and the flow of fuel may be increased or decreased as desired responsive to the sensed carbon monoxide concentration.

In an oxygen and carbon dioxide system, the metering devices 88 may comprise a CO₂ gas valve controlling the flow of carbon dioxide, an oxygen gas valve controlling the flow of oxygen gas, and controller configured to operate the CO₂ gas valve and oxygen gas valve as desired responsive to the sensed temperature, the oxygen concentration in the flue gas, the carbon monoxide concentration in the flue gas, or a combination thereof. Alternatively or in addition, the metering devices 88 may be configured to operate responsive to operator input.

The fuel metering valve 90 may comprise a gas valve controlling the flow of fuel, volatiles, or other gases, and controller configured to operate the gas valve as desired responsive to the sensed temperature, the oxygen concentration in the flue gas, the carbon monoxide concentration in the flue gas, or a combination thereof. Alternatively or in addition, the fuel metering valve 90 may be configured to operate responsive to operator input.

The flow of oxygen gas and carbon dioxide may be directed to enter the furnace at an angle θ to the furnace roof to flow down towards the bed in the direction of flue gas travel such as shown in FIGS. 2 through 4. The gas injection ports 29 may be at an angle θ of between 20 and 90 degrees to the furnace roof to assist the movement of gas toward the exit end of the furnace.

The combination of oxygen gas delivery through the gas injection ports 29 near the roof and fuel delivery through the ports 74 near the reducible material may result in a semi-stationary flame front 76 approximately midway between the roof and the reducible material, radiating energy back to the reducible material above the hearth.

Optionally, a horizontal baffle or hood 78 may be positioned between the reducible material and the burner flame 76 in at least a portion of the furnace near the discharge end positioned to draw a flow of furnace gases under the horizontal baffle. The horizontal baffle 78 may be positioned in the fusion zone 14 and/or at least a portion of the conversion zone 13 enhancing the fluid flow near the reducible material. A flow of furnace gases may be drawn under the horizontal baffle 78 to flow with the direction of movement of the hearth. In this location, the flow of gases under the hood will include mostly CO₂ and water vapor if there is no syn-gas injection. Alternatively or in addition, a reducing material may be delivered adjacent an edge of the horizontal baffle 78 positioned to flow beneath the horizontal baffle with the flow of furnace gases. The reductant may be syn-gas delivered beneath the hood to maintain a high reducing potential under the hood. Alternatively or in addition, the syn-gas may be delivered through port 74′ positioned adjacent the edge of the hood such that the flow of furnace gases draws the syn-gas beneath the hood. Alternatively or in addition, carbonaceous material such as coal may be delivered above the hearth at a position adjacent the edge of the hood such that the flow of furnace gases draws the carbonaceous material under the hood providing a gasified product. This gas stream emerges at the discharge end of the hood and is drawn up into the flame where volatiles are consumed.

Referring now to FIG. 5, the oxy-fuel burner 16 may include burner block 80, a fuel aperture 82, an annular gas port 83 around the fuel aperture 82, and a plurality of gas stream ports 84 arranged around the annular gas port 83 as desired. The fuel aperture 82 and the annular gas port 83 may be positioned about an axis approximately centrally in the burner block 80. As shown in FIG. 5, the oxy-fuel burner 16 may include eight gas stream ports 84 arranged in an arcuate arrangement around the annular gas port 83. Alternatively, the oxy-fuel burner 16 may include between 5 and 16 gas stream ports 84.

The gas stream ports 84 may be spaced around the annular gas port 83 with approximately equidistant spacing between at least a portion of the gas stream ports 84. As shown in FIG. 5, when eight gas stream ports 84 are provided, the ports 84 may be spaced about 45 degrees apart around the annular gas port 83. Alternatively, the gas stream ports 84 may be spaced capable of providing oxygen gas in a desired distribution around the burner. The number of gas stream ports 84 and the relative position of the gas stream ports may be determined to provide desired flame stability and oxygen distribution around the flame.

The oxygen gas may be delivered through the gas stream ports 84 having a nozzle velocity less than about 100 ft/s. Alternatively, the gas nozzle velocity may be between about 60 ft/s and about 200 ft/s. Optionally, the oxygen gas may be mixed with carbon dioxide, nitrogen or other inert gas to reduce the concentration of oxygen in the gas stream ports 84. The gas through the gas stream ports may have an oxygen concentration between about 75% and 95% oxygen by volume. Alternatively, the gas through the gas stream ports may have an oxygen concentration between about 90% and 100% oxygen by volume.

At least one supplemental oxygen port 85 may be provided positioned to direct a stream of oxygen to the fuel flow through the flow from the annular gas port 83. In the embodiment of FIG. 6, a supplemental oxygen port 85 may direct a stream of oxygen at an angle γ toward the center of the burner. The supplemental oxygen port 85 may be directed at an angle γ between about 30 and 60 degrees from the axis toward the center of the burner. The supplemental oxygen port 85 improves flame stability by directing a stream of oxygen to the fuel flow, maintaining the flame.

As discussed above, carbon dioxide may be delivered through the oxy-fuel burner 16. In the burners of FIGS. 5 and 6, the carbon dioxide may be delivered through the annular gas port 83. Delivery of carbon dioxide through the annular gas port 83 provides a separation or buffer between the fuel delivered through the central fuel aperture 82 and oxygen gas delivered through the gas stream ports 84. This arrangement may be useful in increasing the symmetry of the flame shape and reduce the flame temperature at the burner.

The flow of carbon dioxide may be used to recover waste heat from the system. For example, as shown in FIGS. 7 and 8, the flue gas may be processed to separate a stream of carbon dioxide. The carbon dioxide may be heated by the hot flue gas through the heat exchanger 144 before being delivered to the annular gas port 83. The carbon dioxide may be preheated to about 750° F. (about 400° C.) in the heat exchanger 144. Alternatively, for delivery along the furnace, the carbon dioxide may be preheated to between about 400° F. (about 200° C.) and 1500° F. (about 810° C.). Preheating the carbon dioxide may improve flame stability.

The flow of carbon dioxide and oxygen through the burner block provides cooling of the burner, reducing thermal gradients and stresses. The delivery of carbon dioxide through the oxy-fuel burner 16 may be regulated to control the oxygen concentration in the oxy-fuel burner and the flame temperature. Flame temperature is dependent on the oxygen concentration through the burner.

While the invention has been illustrated and described in detail in the foregoing drawings and description, the same is to be considered as illustrative and not restrictive in character, it being understood that only illustrative embodiments thereof have been shown and described, and that all changes and modifications that come within the spirit of the invention described by the following claims are desired to be protected. Additional features of the invention will become apparent to those skilled in the art upon consideration of the description. Modifications may be made without departing from the spirit and scope of the invention.

What is claimed is:

1. A method for producing metallic iron comprising the steps of:
assembling a hearth furnace comprising an entry end and a discharge end, and a moveable hearth comprising refractory material adapted to move reducible material through the furnace from the entry end to the discharge end, and an exhaust stack positioned toward the entry end of the furnace,
providing a hearth material layer comprising carbonaceous material above the refractory material,
providing a layer of reducible material comprising reducing material and iron bearing material arranged in a plurality of discrete portions above at least a portion of the hearth material layer,
delivering a flow of gases into the hearth furnace through burners, gas injection ports, or a combination thereof directing a flow of gases toward the entry end selected from a group consisting of combustible fuel, oxygen and carbon dioxide, oxygen and flue gas, oxygen and air, or a combination thereof to heat the furnace to a temperature sufficient to at least partially reduce the reducible material,
increasing the velocity of the flow of gas to greater than 4 feet per second along the furnace, and
heating the layer of reducible material to at least partially reduce the reducible material.

2. The method for producing metallic iron of claim 1 further comprising
providing at least one burner adjacent the discharge end directing a flow of gases toward the entry end.

3. The method for producing metallic iron of claim 1 where the step of delivering a flow of gases into the hearth furnace includes delivering between about 10% and 40% oxygen gas by volume.

4. The method for producing metallic iron of claim 1 further comprising the step of:
delivering a flow of flue gas from the furnace through the exhaust stack positioned toward the entry end of the furnace.

5. The method for producing metallic iron of claim 1 where the step of assembling a hearth furnace includes providing a roof higher at the entry end and lower at the discharge end.

6. The method for producing metallic iron of claim 5, the furnace including roof restrictions performing the step of increasing the velocity of the flow of gas.

7. The method for producing metallic iron of claim 1 where the step of assembling a hearth furnace includes providing a linear hearth furnace.

8. The method for producing metallic iron of claim 1 where the step of assembling a hearth furnace includes providing a rotary hearth furnace.

9. The method for producing metallic iron of claim 1 where the step of delivering a flow of gases into the furnace includes delivering oxygen gas and carbon dioxide at a plurality of locations along the furnace.

10. The method for producing metallic iron of claim 1 further comprising the step of:
delivering a flow of fuel into the furnace above the reducible material.

11. The method for producing metallic iron of claim 10 where the step of delivering a flow of fuel includes delivering fuel above the reducible material at a plurality of locations along the furnace.

12. The method for producing metallic iron of claim 10 where the fuel is one selected from the group consisting of syn-gas, methane, propane, natural gas, and a combination of two or more thereof.

13. The method for producing metallic iron of claim 10 further comprising the steps of:
sensing the temperature of the furnace at a desired location, and delivering the flow of fuel above the reducible material responsive to the sensed temperature.

14. The method for producing metallic iron of claim 4 further comprising the step of processing at least a portion of the flue gas in a gasifier to produce syn-gas, and delivering a flow of the syn-gas into the furnace above the reducible material.

15. The method for producing metallic iron of claim 14, prior to the step of delivering a flow of the syn-gas into the furnace further comprising the steps of:
directing the flue gas through a heat exchanger and preheating the syn-gas in the heat exchanger.

16. The method for producing metallic iron of claim 4 further comprising the step of
processing the flue gas to produce a gas stream having a composition of at least 90% carbon dioxide by oxidizing carbon monoxide and hydrogen, treating the gas stream to remove at least one of sulfur-containing and halogen-containing compounds, and condensing water vapor from the gas stream.

17. The method for producing metallic iron of claim 16 where the step of delivering a flow of gases into the furnace includes carbon dioxide from the gas stream processed from the flue gas.

18. The method for producing metallic iron of claim 4, prior to the step of delivering a flow of gases into the furnace further comprising the step of:
directing the flue gas through a heat exchanger and preheating the flow of gases in the heat exchanger.

19. The method for producing metallic iron of claim 4 further comprising the step of:
delivering a flow of fuel into the furnace above the reducible material.

20. The method for producing metallic iron of claim 19, prior to the step of delivering a flow of fuel into the furnace further comprising the steps of:
directing the flue gas through a heat exchanger and preheating the fuel in the heat exchanger.

21. The method for producing metallic iron of claim 1 further comprising the steps of:
sensing the temperature of the furnace at a desired location, and
delivering the flow of gases into the furnace responsive to the sensed temperature.

22. The method for producing metallic iron of claim 4 further comprising the steps of:
sensing the oxygen concentration in the flue gas, and
delivering the flow of gases and into the furnace responsive to the sensed oxygen concentration.

23. The method for producing metallic iron of claim 1 where the step of delivering a flow of gases into the furnace comprises delivering the flow of gases through a plurality of gas injection ports along the furnace.

24. The method for producing metallic iron of claim 1, the hearth furnace comprising at least a conversion zone is heated to at least 2350° F. (1290° C.).

25. The method for producing metallic iron of claim 1, the hearth furnace comprising at least a fusion zone heated to at least about 2550° F. (about 1400° C.).

26. The method for producing metallic iron of claim 24 comprising in addition the step of assembling a drying zone adjacent the conversion zone in the hearth furnace.

27. The method for producing metallic iron of claim 26 where the drying zone is heated to between about 200-400° F. (about 90-200° C.).

28. The method for producing metallic iron of claim 1 where the step of providing reducible material includes discrete portions in pre-formed briquettes or balls.

29. The method for producing metallic iron of claim 1 comprising the additional step of providing an overlayer of coarse carbonaceous material over at least a portion of the layer of reducible material where the coarse carbonaceous material has an average particle size greater than an average particle size of the hearth material layer carbonaceous material.

30. The method for producing metallic iron of claim 1 comprising the additional step of providing an overlayer of coarse carbonaceous material over at least a portion of the layer of reducible material where the overlayer of coarse carbonaceous material comprises discrete particles having sizes greater than about 4 mesh.

31. The method for producing metallic iron of claim 1 comprising the additional step of providing a horizontal baffle above the reducible material in at least a portion of the furnace near the discharge end positioned to draw a flow of furnace gases under the horizontal baffle.

32. The method for producing metallic iron of claim 31 comprising the additional step of delivering a reducing material adjacent an edge of the horizontal baffle positioned to flow beneath the horizontal baffle with the flow of furnace gases.

33. The method for producing metallic iron of claim 1 where the step of providing a layer of reducible material includes a predetermined amount of iron bearing material and between about 80 percent and about 110 percent of the stoichiometric amount of reducing material necessary for complete iron reduction of the iron bearing material.

34. The method for producing metallic iron of claim 33 where the step of providing reducible material involves iron-bearing metallurgical waste comprising a mixture of mill scale and one selected from the group of DRI fines, processed EAF dust, BOF sludge, blast furnace dust, wash ore tailings, red ore tailings, and mixtures thereof.

35. The method for producing metallic iron of claim 1 where the step of providing a layer of reducible material includes a predetermined amount of iron bearing material and between about 70 percent and about 90 percent of the stoichiometric amount of reducing material necessary for complete iron reduction of the iron bearing material.

36. The method for producing metallic iron of claim 35 where the step of providing the reducible material involves iron bearing material selected from the group consisting of magnetite, hematite, and combinations thereof.

37. The method for producing metallic iron of claim 1 where the reducing material contains at least a material selected from the group consisting of, anthracite coal, coke, char, bituminous coal, sub-bituminous coal and combinations thereof.

38. A hearth furnace for producing metallic iron comprising:
an entry end and a discharge end, and a moveable hearth therebetween comprising refractory material adapted to move reducible material through the furnace from the entry end to the discharge end,
an exhaust stack positioned toward the entry end of the furnace,
at least one burner adjacent the discharge end positioned to direct a flow of gases toward the entry end, and
at least one gas injection port adapted to deliver a flow of gases selected from a group consisting of combustible fuel, oxygen gas and carbon dioxide, oxygen and flue gas, oxygen and air, or a combination thereof, into the hearth furnace to heat the furnace to a temperature sufficient to at least partially reduce the reducible material.

39. The hearth furnace of claim 38 further comprising a roof higher at the entry end and lower at the discharge end.

40. The hearth furnace of claim 38 where the hearth furnace is a linear hearth furnace.

41. The hearth furnace of claim 38 where the hearth furnace is a rotary hearth furnace.

42. The hearth furnace of claim 38 where the at least one gas injection port comprises a plurality of gas injection ports positioned along the furnace.

43. The hearth furnace of claim 38 further comprising a plurality of gas ports positioned along the furnace adapted to deliver a flow of fuel into the furnace above the reducible material.

44. The hearth furnace of claim 43 further comprising a temperature sensor adapted to sensing the temperature of the furnace at a desired location.

45. The hearth furnace of claim 44 further comprising a fuel metering valve adapted to delivering the flow of fuel above the reducible material responsive to the sensed temperature.

46. The hearth furnace of claim 38 further comprising a temperature sensor adapted to sensing the temperature of the furnace at a desired location.

47. The hearth furnace of claim 46 further comprising a metering device adapted to delivering the flow of gases into the furnace responsive to the sensed temperature.

48. The hearth furnace of claim 43 further comprising a gas analyzing sensor adapted to sensing the oxygen concentration in flue gas exhausted from the exhaust stack.

49. The hearth furnace of claim 48 further comprising a fuel metering valve adapted to delivering the flow of fuel above the reducible material responsive to the sensed oxygen concentration.

50. The hearth furnace of claim 38 further comprising a gas analyzing sensor adapted to sensing the oxygen concentration in flue gas exhausted from the exhaust stack.

51. The hearth furnace of claim 50 further comprising a metering device adapted to delivering the flow of gases into the furnace responsive to the sensed oxygen concentration.

52. The hearth furnace of claim 38 further comprising a heat exchanger connected to at least a portion of the flue gas adapted to preheat the flow of gases in the heat exchanger.

53. The hearth furnace of claim 43 further comprising a heat exchanger connected to at least a portion of the flue gas adapted to preheat the flow of fuel in the heat exchanger.

54. The hearth furnace of claim 38 further comprising a gasifier adapted to processing at least a portion of flue gas from the exhaust stack to produce syn-gas.

55. The hearth furnace of claim 38 further comprising a scrubber adapted to processing at least a portion of flue gas from the exhaust stack to produce a gas stream comprising at least 90% carbon dioxide.

56. A linear hearth furnace for producing metallic iron comprising:
an entry end and a discharge end, and a moveable hearth therebetween comprising refractory material adapted to move reducible material through the furnace from the entry end to the discharge end,
an exhaust stack positioned toward the entry end of the furnace,
a plurality of gas injection ports adapted to deliver a flow of gases selected from a group consisting of combustible fuel, oxygen gas and carbon dioxide, oxygen and flue gas, oxygen and air, or a combination thereof, into the hearth furnace to heat the furnace to a temperature sufficient to at least partially reduce the reducible material, and
a plurality of flow restrictions along the furnace adapted to increase the velocity of the flow of gas to greater than 4 feet per second.

57. The linear hearth furnace of claim 56 further comprising a roof higher at the entry end and lower at the discharge end.

58. The hearth furnace of claim 56 where the hearth furnace is a linear hearth furnace.

59. The hearth furnace of claim 56 where the hearth furnace is a rotary hearth furnace.

60. The linear hearth furnace of claim 56 where the plurality of gas injection ports are positioned along the furnace.

61. The linear hearth furnace of claim 56 where the plurality of gas ports are positioned along the furnace and adapted to deliver a flow of fuel into the furnace above the reducible material.

62. The linear hearth furnace of claim 61 further comprising a temperature sensor adapted to sensing the temperature of the furnace at a desired location.

63. The linear hearth furnace of claim 62 further comprising a fuel metering valve adapted to delivering the flow of fuel above the reducible material responsive to the sensed temperature.

64. The linear hearth furnace of claim 56 further comprising a temperature sensor adapted to sensing the temperature of the furnace at a desired location.

65. The linear hearth furnace of claim 64 further comprising a metering device adapted to delivering the flow of gases into the furnace responsive to the sensed temperature.

66. The linear hearth furnace of claim 61 further comprising a gas analyzing sensor adapted to sensing the oxygen concentration in flue gas exhausted from the exhaust stack.

67. The linear hearth furnace of claim 66 further comprising a fuel metering valve adapted to delivering the flow of fuel above the reducible material responsive to the sensed oxygen concentration.

68. The linear hearth furnace of claim 56 further comprising a gas analyzing sensor adapted to sensing the oxygen concentration in flue gas exhausted from the exhaust stack.

69. The linear hearth furnace of claim 68 further comprising a metering device adapted to delivering the flow of gases into the furnace responsive to the sensed oxygen concentration.

70. The linear hearth furnace of claim 56 further comprising a heat exchanger connected to at least a portion of the flue gas adapted to preheat the flow of gases in the heat exchanger.

71. The linear hearth furnace of claim 61 further comprising a heat exchanger connected to at least a portion of the flue gas adapted to preheat the flow of fuel in the heat exchanger.

72. The linear hearth furnace of claim 56 further comprising a gasifier adapted to processing at least a portion of flue gas from the exhaust stack to produce syn-gas.

73. The linear hearth furnace of claim 56 further comprising a scrubber adapted to processing at least a portion of flue gas from the exhaust stack to produce a gas stream comprising at least 90% carbon dioxide.
